(19) United States
(12) Patent Application Publication
(10) Pub. No.: US 2019/0213544 A1
(43) Pub. Date: Jul. 11, 2019

(54) COMPUTER-BASED PLATFORM FOR MANUFACTURING AS A SERVICE

(71) Applicant: Techniplas, LLC, Nashotah, WI (US)

(72) Inventors: Daniel Spirig, Widnau (CH); Martin Boppart, Stäfa (CH); Avi N. Reichental, Carpenteria, CA (US)

(21) Appl. No.: 16/238,326

(22) Filed: Jan. 2, 2019

Related U.S. Application Data
(60) Provisional application No. 62/614,843, filed on Jan. 8, 2018.

(51) Int. Cl. G06Q 10/08; G06Q 30/06; G06F 3/0482; G06F 3/0481; G06Q 30/08; G06F 17/50

(52) U.S. Cl. CPC G06Q 10/0875; G06Q 30/0641; G06F 3/0482; G06F 17/50; G06Q 30/0633; G06Q 30/08; G06F 3/04815

(57) ABSTRACT

Disclosed herein are systems, methods, and machine-readable media for providing services concerning creating order specifications and coordinating orders for manufacturing and distribution of three-dimensional items.

### RELATED APPLICATIONS

This application claims the benefit of U.S. Provisional Patent Application No. 62/614,843, filed on Jan. 8, 2018, the disclosure of which is incorporated herein by reference in its entirety.

### FIELD OF THE INVENTION

The present invention relates to apparatuses, systems, computer readable media, and methods for the provision of services concerning creating a order specifications and coordinating orders for manufacturing and distribution of three-dimensional items.

### BACKGROUND

Current plastics-oriented manufacturing processes, including process for injection molding of plastics and additive manufacturing technologies (often referred to as “3D printing”), are characterized by long lead times for concept development, engineering modeling, tooling etc. In addition, there can be long with times for equipment availability as machine capacities are often reserved many months in advance of actual production. The need to make such reservations long in advance of actual production runs often means that product designs must be “frozen” months in advance of such production, with any later design changes causing the need for expensive and lengthy tooling and, sometimes, equipment modifications. As a result of these and other issues, production equipment often goes unused for extended periods of time as developers are unwilling to commit to production until designs have been fully vetted and validated.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1 shows a system for providing services concerning creating order specifications for manufacturing and distribution of three-dimensional items, in accordance with some embodiments of the invention;

FIGS. 2A-2R show exemplary portions of user interfaces for a developer-user interacting with the system of FIG. 1, in accordance with some embodiments of the invention;

FIG. 3 shows a flow chart depicting an exemplary process for providing services concerning creating order specifications and coordinating orders for manufacturing and distribution of three-dimensional items, in accordance with some embodiments of the invention.

### DETAILED DESCRIPTION

The present invention provides a computer-based platform for “manufacturing as a service” (MAAS) that leverages this unutilized capacity of production equipment and exposes it to developers seeking to have their designs fabricated. The platform allows suppliers, especially those with plastics industry expertise, to register capacities for injection molding equipment, 3D printing equipment, toolings, raw materials, etc. Developers are afforded the opportunity to specify their needs through design files, fabrication preferences and quantities, etc. based on the supplier information stored in one or more databases, the platform then provides real-time quotes for services that will meet the developer's specified needs and preferences at production facilities in or with access to geographies and/or markets of interest to the developer. The quotes can be provided at any level of granularity desired by the developer, and may include total costs of production throughout a supply chain based on current market data, historical market data, and/or reasoned analysis. Various quotes may be provided by different suppliers, and information, including, optionally, customer feedback, provided concerning these suppliers, so as to allow the developer to make informed decisions about where to have designs fabricated.

In addition to simply offering quotes for the provided designs, options provided by the present platform may allow for “lightweighting” of a developer's design so as to reduce the weight and/or cost of a finished product. For example, the platform may offer access to a system for optimizing a design based on developer-provided constraints for specified parameters. Further, costs and timings for specialized toolings required for manufacture may be quoted based on producing of such implements using identified or user-selected additive manufacturing capabilities managed via the present platform. Finally, the present platform may also provide developers with options for selecting distribution solutions of the finished products.

From a user-developer's standpoint, the platform provides an interface for the developer to supply information concerning the design/product to be manufactured (e.g., in the form of drawings, specification, etc.), preferences/requirements for the place of manufacture, quantities, materials, etc. based on this information, and the stored database of suppliers' capacities, capabilities, etc., the platform determines and provides a “best price” solution and presents same to the developer. In some cases, the developer may be provided only this best price solution, but more generally the developer may be provided with a number of solutions, which may be ranked according to various criteria, and afforded the option to choose one or more from among them.

In some cases, prior to choosing a solution, the developer may be provided with options for optimizing the design, for example based on topology (weight), manufacturing location, shipping logistics, materials used, additive manufacturing technology and/or other manufacturing processes to be employed, etc. These optimization options draw upon information stored by the platform concerning the various suppliers available to meet the requested manufacturing project. The design parameters and optimizations may be specified through an iterative process in which the developer tracks price/time options through different combinations of such selections. In some cases, the platform may provide the user with a layout of various manufacturing options (e.g., ones that optimize around different parameters or sets of parameters) to allow for side-by-side comparisons.

Ultimately, the developer makes a selection and places an order for the manufacture of the provided design. The order may be based on one of the optimized solutions provided by the platform, or may be a completely user-specified manufacturing solution that selects individual options from different solutions offered by the platform. In some cases, the selection may be made based on individually negotiated terms with a manufacturer, where the present platform provides a communication facility for a developer to enter into such negotiations with one or more manufacturers. Alternatively, or in addition, the platform may facilitate an auction process where suppliers are able to offer individualized quotes for a project or portion(s) thereof. The use of such auctions is especially useful in cases where little to no custom toolings, etc. are required and all that is needed is raw materials and machine capacity. The platform also allows a developer to track the process of an order through the manufacturing and delivery (and, if necessary, return) processes.

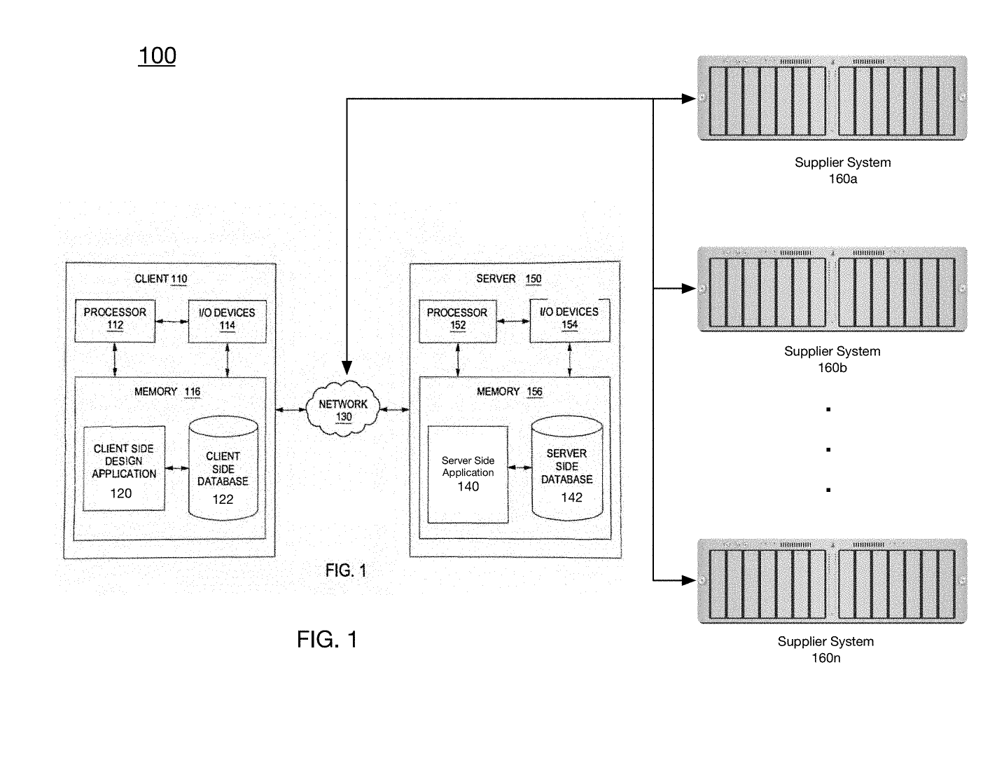

FIG. 1 illustrates a system 100 configured to implement one or more aspects of the present invention. As shown, system 100 includes a client 110 coupled via a network 130 to a server 150. Although only one client 110 and one server 150 are illustrated, in practice there may be multiple clients 110 that communicate with one or more servers 150 over network 150. Multiple servers 150 may be implemented as a server farm that, from the standpoint of a client 110, appear to be single server instance. For simplicity of description, client 110 and server 150 will be referred to in the singular.

Client 110 may be any technically feasible variety of client computing device, including a desktop computer, laptop computer, mobile device, and so forth. Network 150 may be any technically feasible set of interconnected communication links, including a local area network (LAN), wide area network (WAN), or the Internet, among others. Server 150 may be any technically feasible type of server computing device, including a remote virtualized instance of a computing device, one or more physical cloud-based computing devices, a mixture of the two, a portion of a datacenter, and so forth.

Client 110 includes processor 112, input/output (I/O) devices 114, and memory 116, coupled together. Processor 112 may be any technically feasible form of processing device configured process data and execute program code. Processor 112 could be, for example, a central processing unit (CPU), a graphics processing unit (GPU), an application-specific integrated circuit (ASIC), a field-programmable gate array (FPGA), and so forth. I/O devices 114 may include devices configured to receive input, including, for example, a keyboard, a mouse, and so forth. I/O devices 114 may also include devices configured to provide output, including, for example, a display device, a speaker, and so forth. I/O devices 114 may further include devices configured to both receive and provide input and output, respectively, including, for example, a touchscreen, a universal serial bus (USB) port, and so forth.

Memory 116 may be any technically feasible storage medium configured to store data and software applications. Memory 116 could be, for example, a hard disk, a random access memory (RAM) module, a read-only memory (ROM), and so forth, including a combination of such storage mediums. Memory 116 includes client-side design application 120 and client-side database 122. Client-side design application 120 is a software application that, when executed by processor 112, causes processor 112 to generate a rendering of an object. In doing so, client-side design application 120 may access client-side database 122.

Server 150 includes processor 152, 110 devices 154, and memory 156, coupled together. Processor 152 may be any technically feasible form of processing device configured to process data and execute program code, including a CPU, a GPU, an ASIC, an FPGA, and so forth. I/O devices 114 may include devices configured to receive input, devices configured to provide output, and devices configured to both receive and provide input and output, respectively. Memory 156 may be any technically feasible storage medium configured to store data and software applications, including a hard disk, a RAM module, a ROM, and so forth, including combinations of the foregoing. Memory 156 includes server-side application 140 and server-side database 142. Server-side application 140 is a software application that, when executed by processor 156, causes processor 152 to perform the functions of the platform for manufacturing as a service as described herein. In doing so, server-side application 140 may access server-side database 142. Server-side application 140 may also interoperate with client-side design application 120 and access client-side database 122.

Also communicably coupled to server 150 via network 130 are one or more supplier systems 160-a-160-n. Supplier systems 160-a-160-n may be servers and associated databases instantiated at one or more supplier locations to provide server 150 with information concerning respective supplier capacities, etc., and to accept orders, participate in auctions, etc., as discussed above. The supplier systems each may include processor, memory, and other resources, similar to those included in client 110 and server 150.

In operation, client-side application 120 and server-side application 140, cooperate to implement the MAAS functionality described herein, based on information obtained from the supplier systems and computational processes provide by server 150. In doing so, either one or both of client-side application 120 and server-side application 14 may access either one or both of client-side database 122 and server-side database 142.

Generally, through client-side application 120, a developer-user generates a design for an article of manufacture that satisfies criteria associated with user-defined constraints. That design is provided to server 150 via a user interface, and server-side application 140 may further receive input from the developer-user that allows for the provision of price and delivery quotes based on desired parameters that the manufacturing and delivery of the article should and/or must comply with. Such input may be assisted through a prompt-and-response dialog between the server-side application and the developer-user in which the developer-user is guided through a set of questions tailored to the article being manufactured and/or desired manufacturing/delivery technologies to be employed. For example, if the article to be manufactured can be produced in any of several additive manufacturing processes, the system may guide the developer-user through selection of a preferred process by prompting the user to supply information concerning raw materials, pricing, delivery times, etc. Over time, the system may develop and maintain a database of designs that can be drawn upon (e.g., as examples) for assisting with new designs for various articles.

Based on the design parameters and constraints entered, server-side application 140 then generates a custom quote the manufacture/delivery of the article, optionally optimized for the specified parameters, constraints, a specified or recommended manufacturing process (e.g., 3D printing, injection molding, etc.), etc. and delivers the quote in a format suited to the user's preference. To develop the quote, server-side application 140 searches database 142 to identify and retrieve information relevant to available capacities for meeting the design outlined by the constraints (i.e., type of manufacturing process, material considerations, etc.) and uses this information, along with the design information entered by the developer-user as parameters for producing the quote.

One of the advantages of this technique is that the end-user need not attempt to consider all possible approaches to solving the manufacturing problem, or delivery options. Further, server-side application 140 can also generate actual designs for supplier systems 160a-160n based on those approaches, thereby alleviating the burden of generating designs from the developer-user. Server-side application 140 may invoke various data and processing stages in performing the processes described herein. For example, the application may include a module for receiving input of a design file (in various formats), a module for defining design constraints, an optional module for selection of optimization algorithm(s) (where such selection is permitted) and performing such optimizations, and a module for delivering a quote based on an optimized design (or other output, as appropriate). Database 142 includes data that is processed by server-side application 140 when performing these tasks.

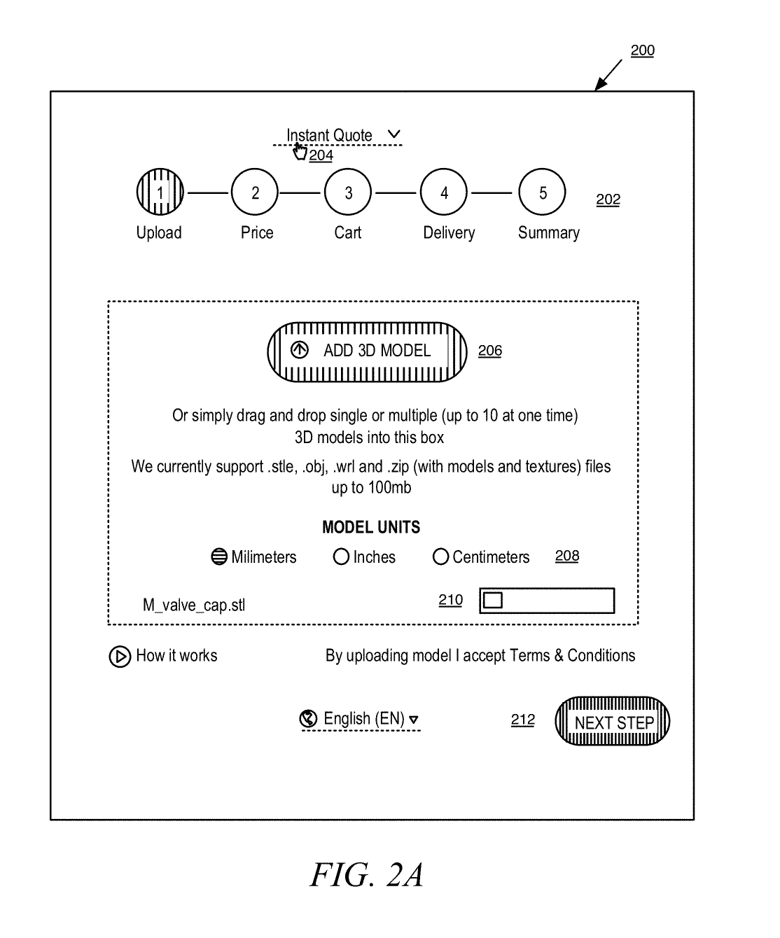

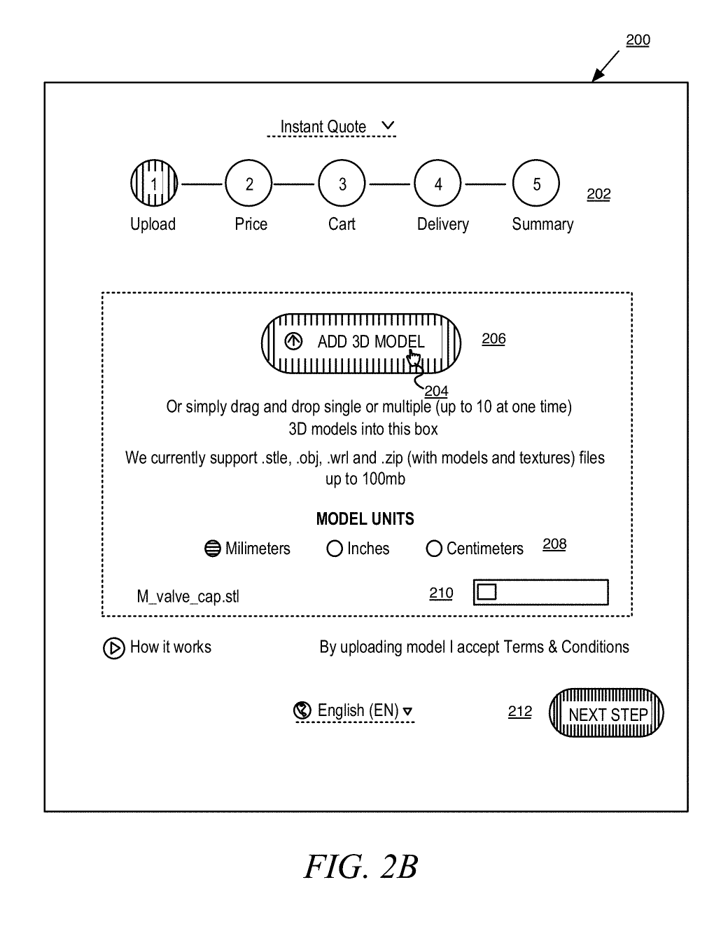

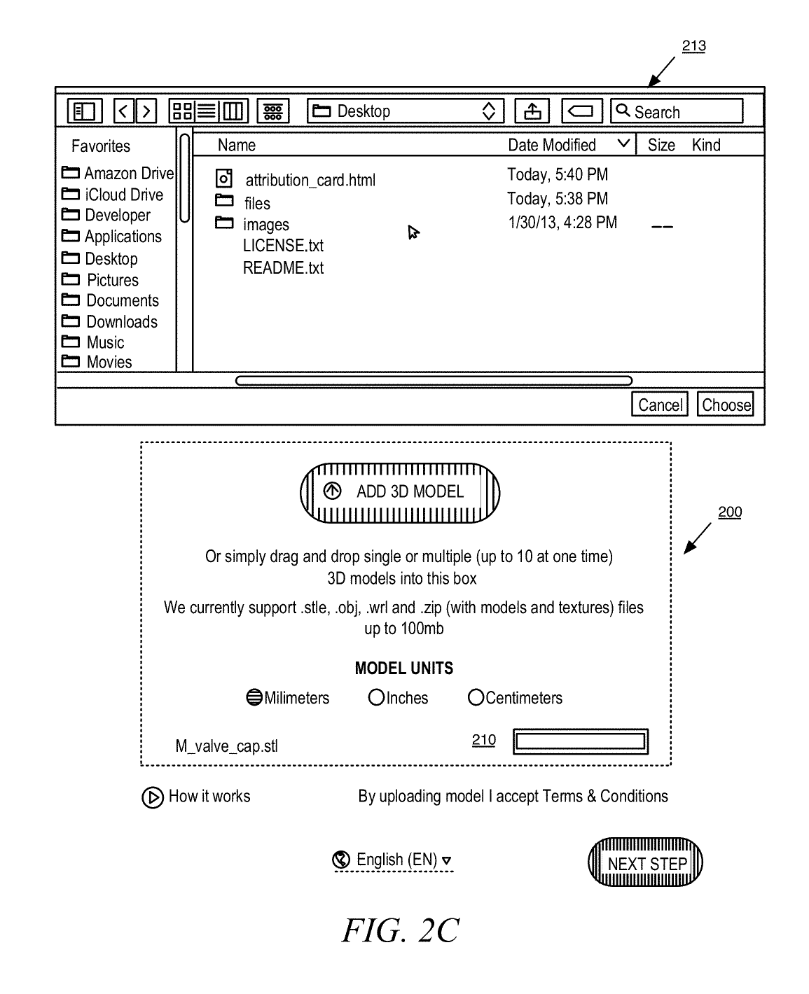

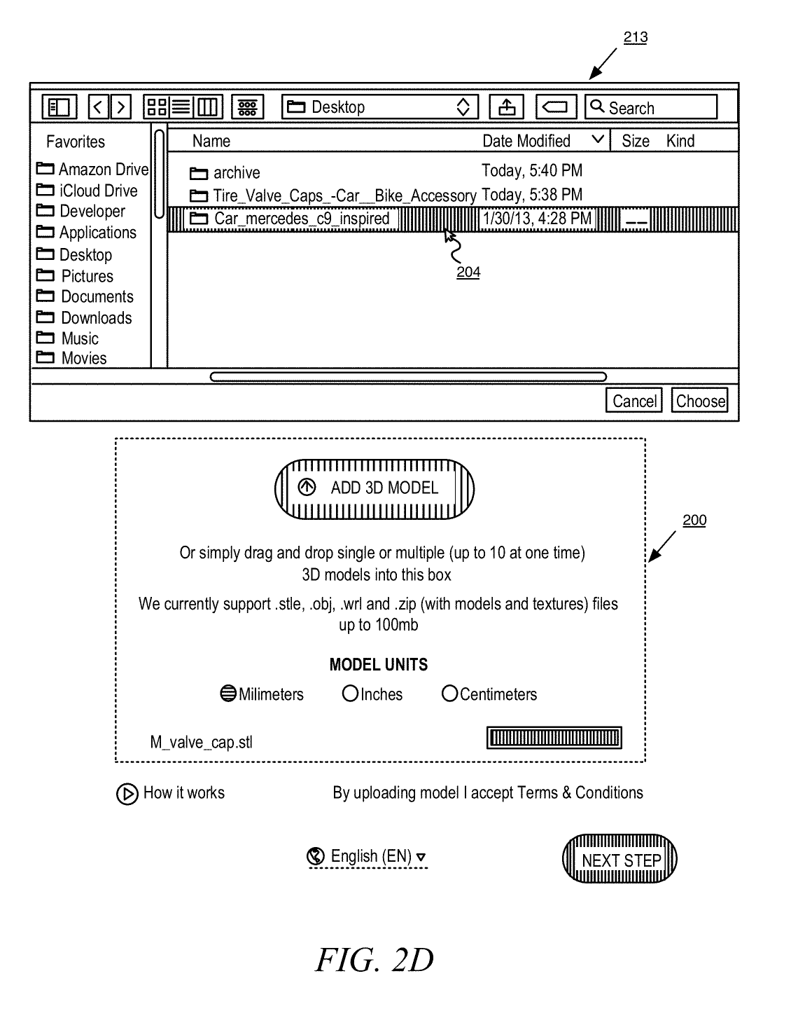

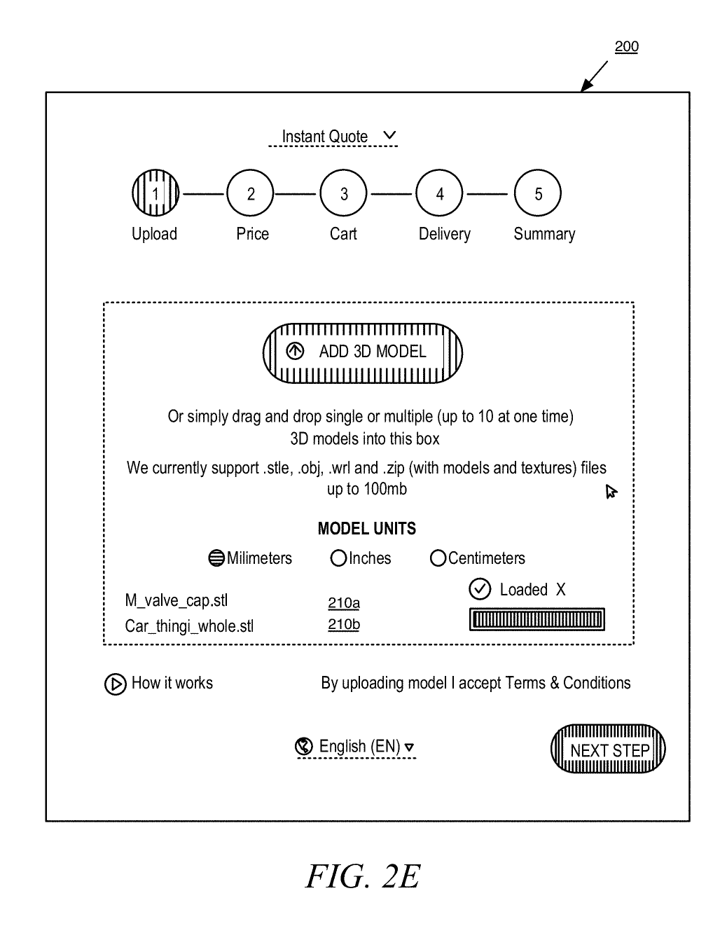

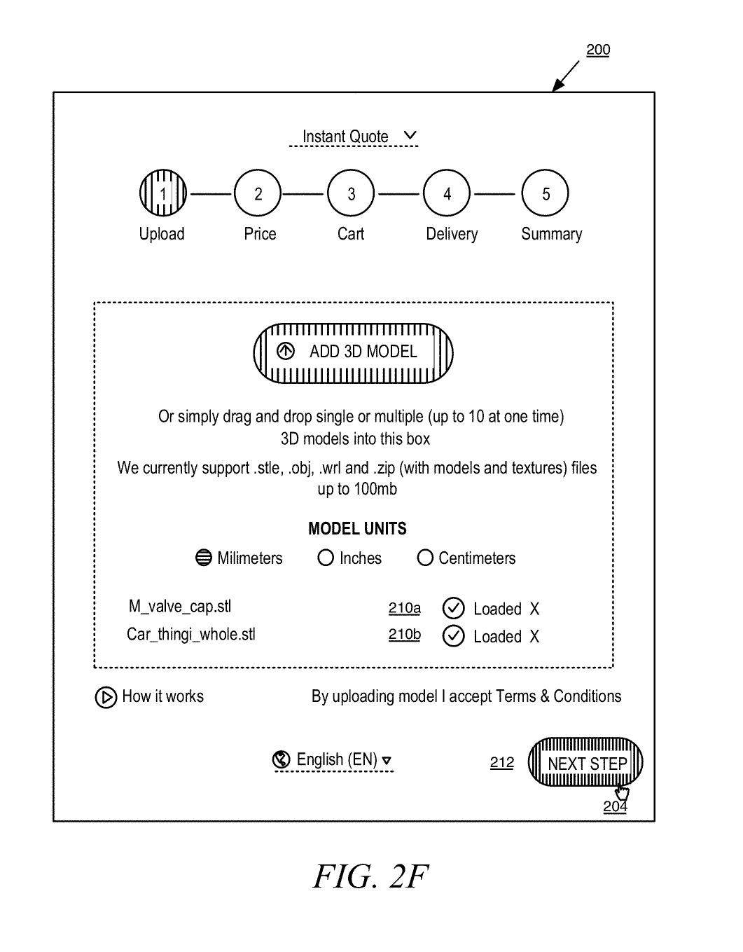

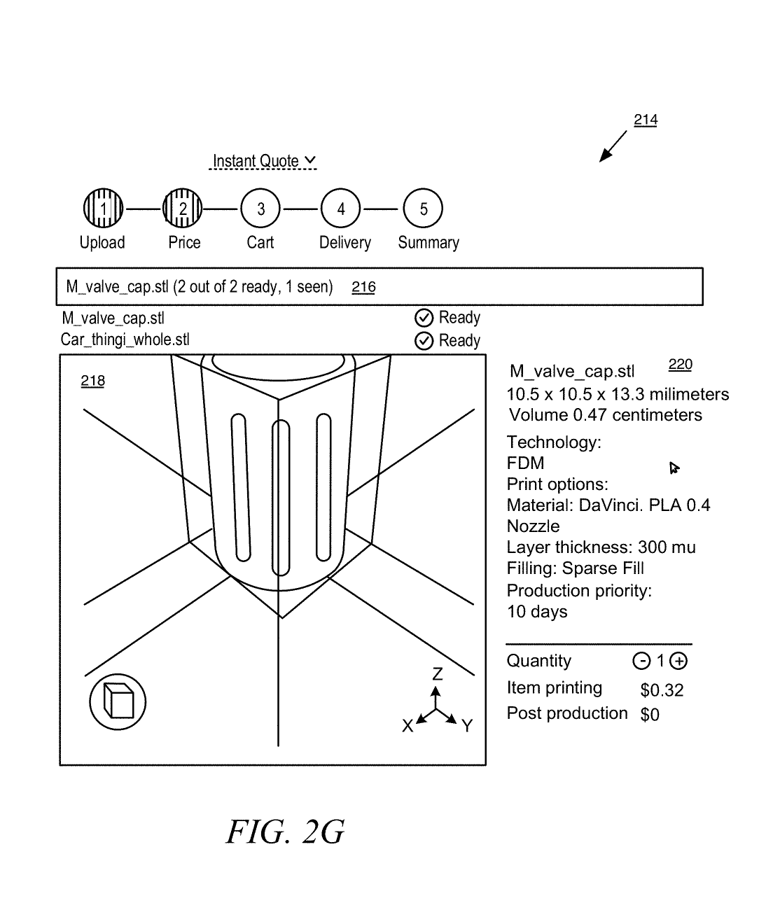

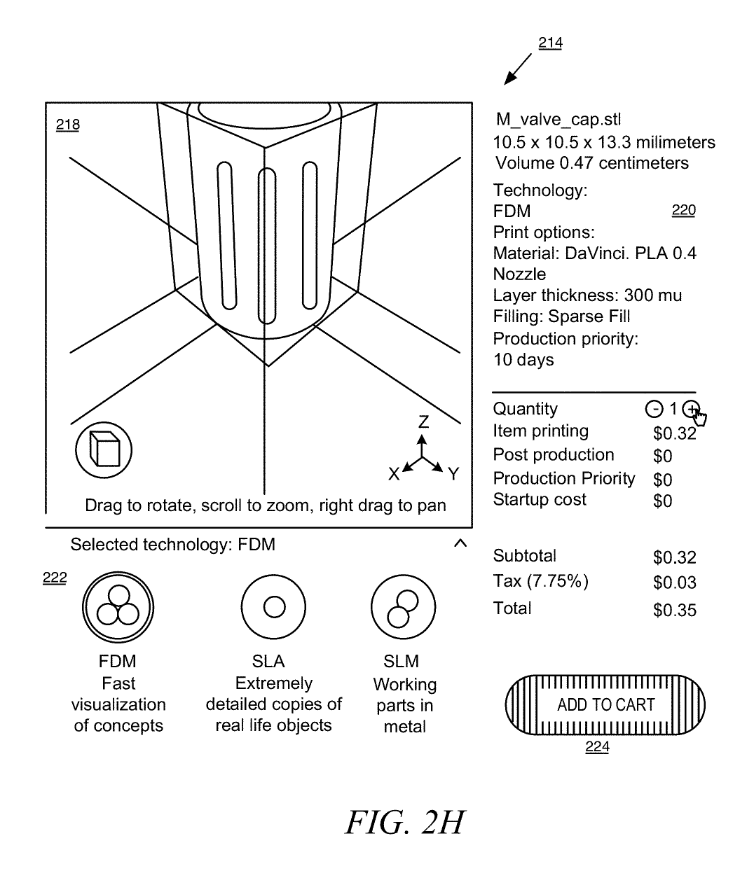

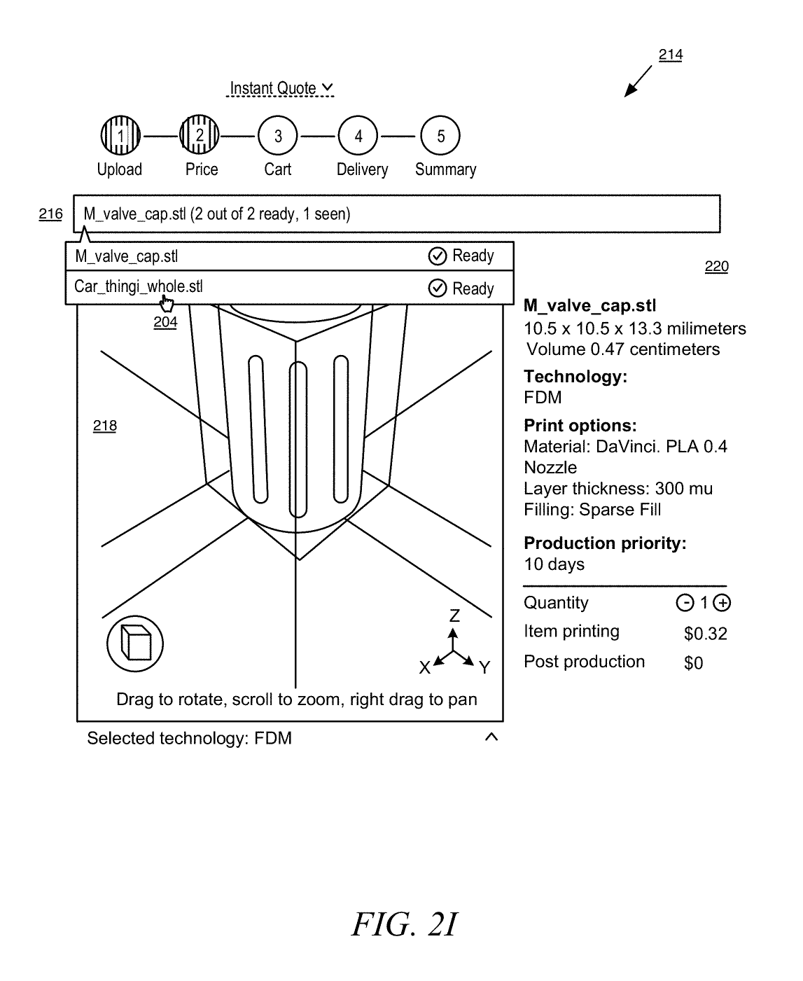

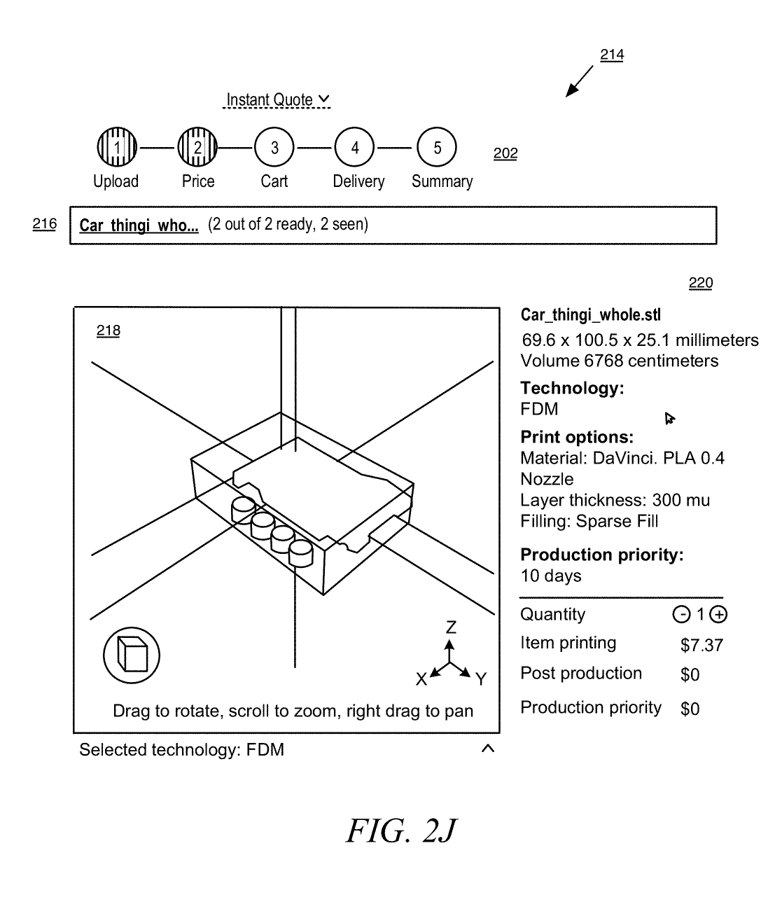

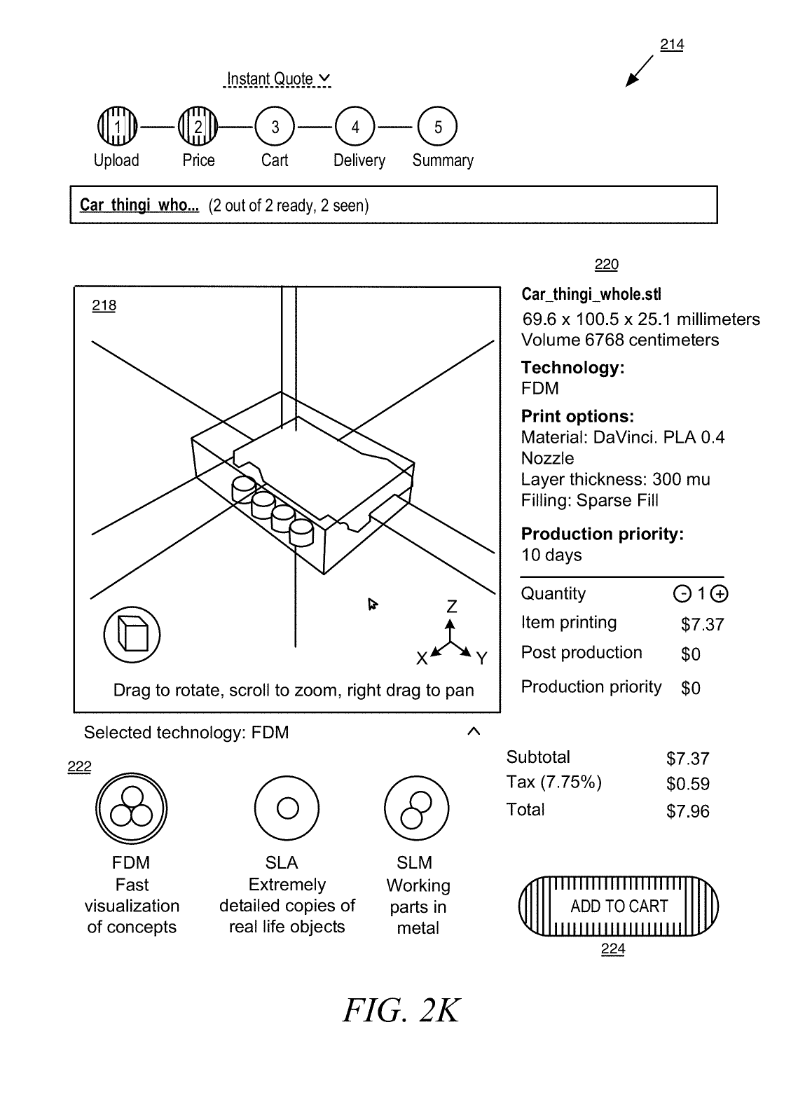

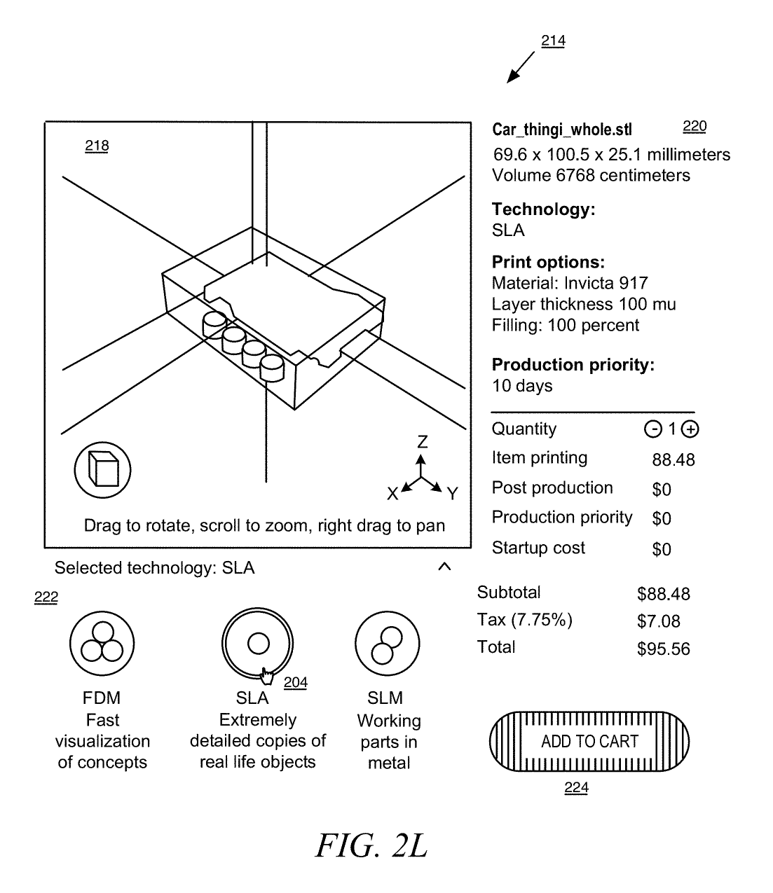

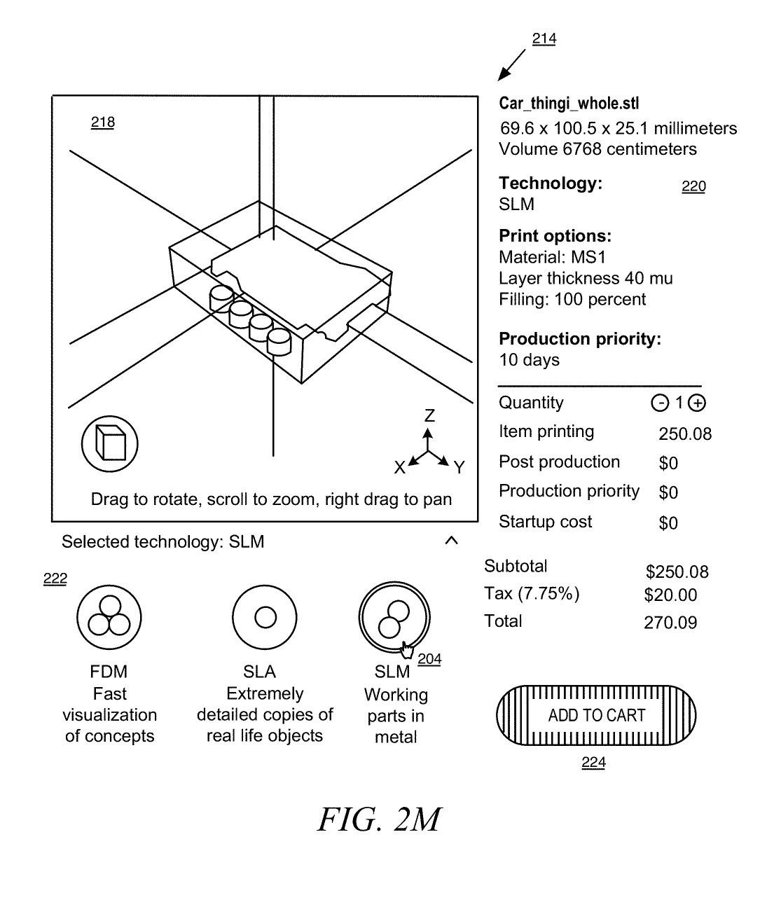

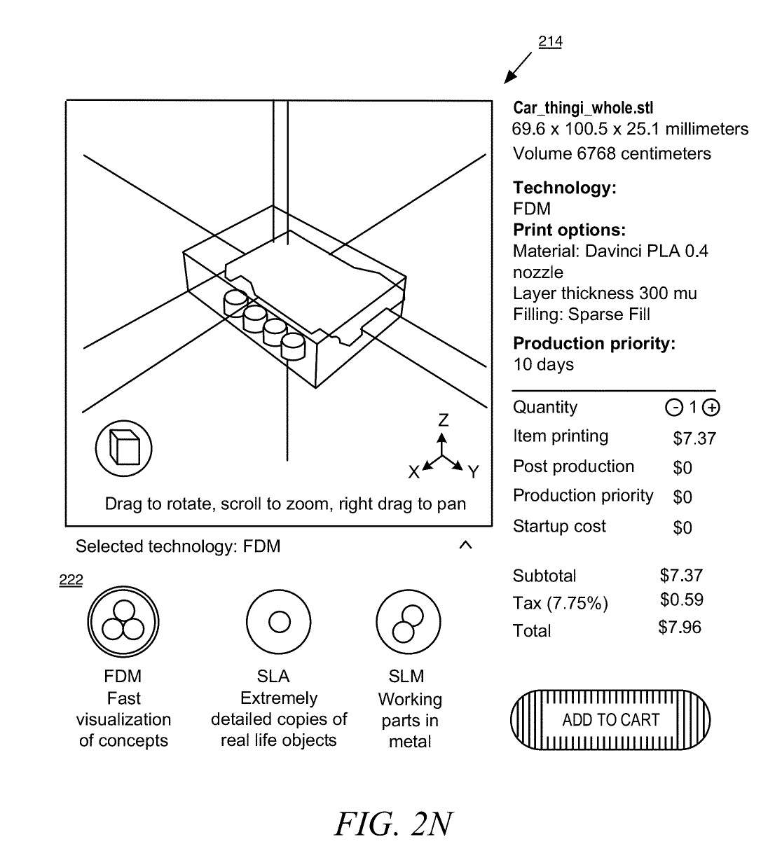

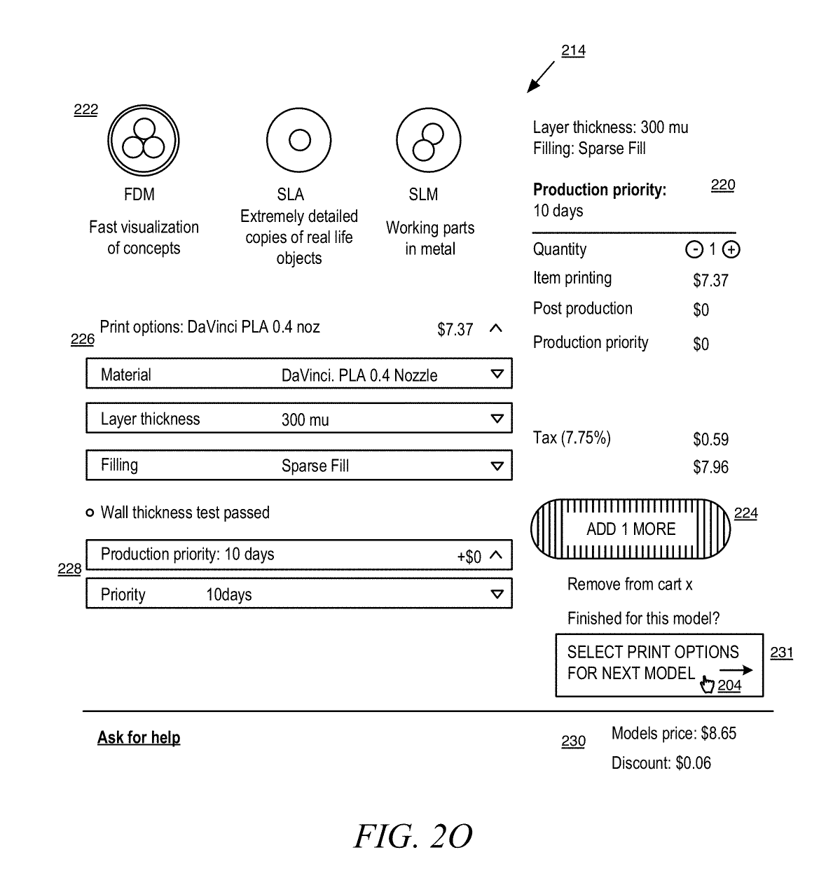

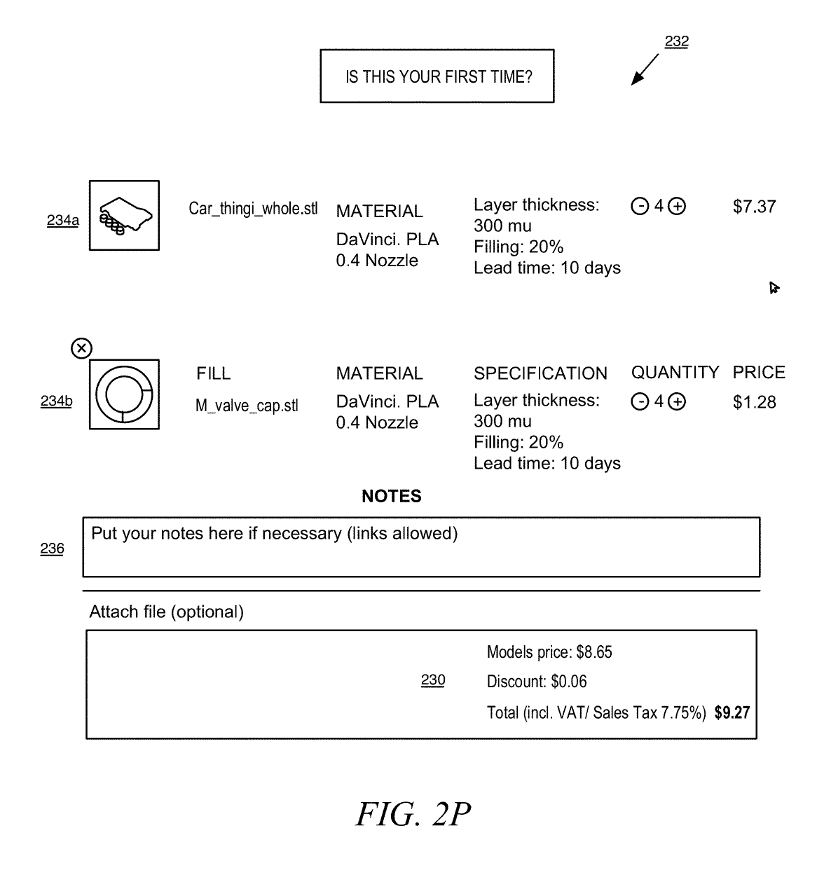

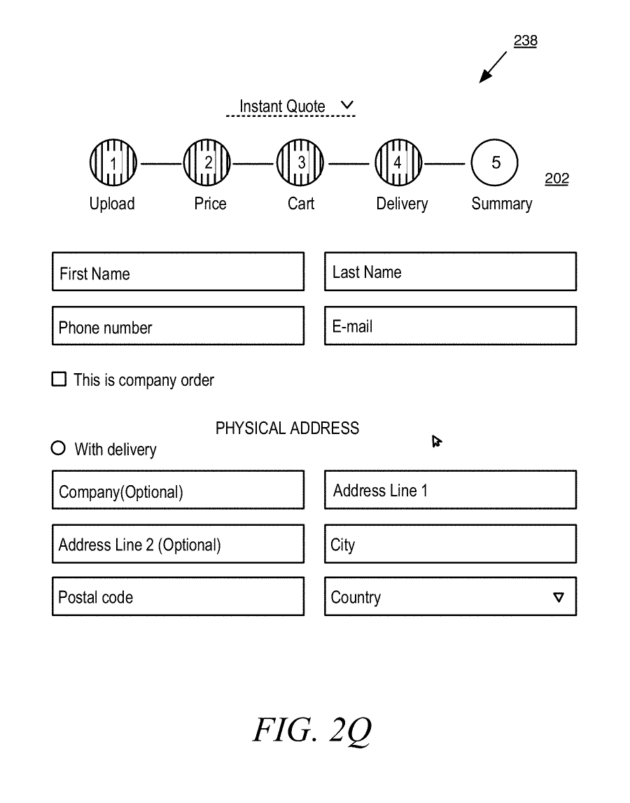

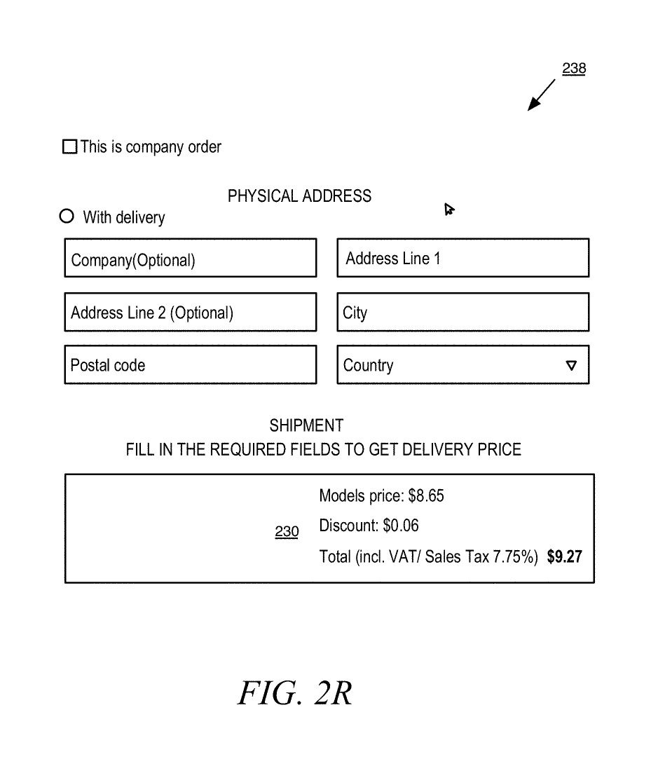

FIGS. 2A-2R illustrate examples of portions of user interfaces for a developer-user interacting with the present platform for MAAS in accordance with embodiments of the present invention.

FIG. 2A shows an exemplary upload user interface 200 that permits a developer-user to provide one or more 3D model files for evaluation and rendering by the platform. Upload user interface 200 includes a navigation indicator 202 for indicating the current stage of a process for receiving a quote from the platform that progresses from upload, to price, to cart, to delivery, to summary (i.e., highlighting, in user interface 200, the “upload” stage). In certain embodiments, navigation indicator 202 may receive a selection of a stage and responsively cause the developer-user to proceed to the selected stage. UI 200 may further include a means for receiving user selections of controls in the user interface, such as cursor 204 that is controlled by the developer-user. UI 200 may further include model upload control 206 for initiating the upload of a new 3D model file, model units control 208, for identifying the units corresponding to shapes represented in the 3D model file (e.g., by specifying the units in millimeters, inches, or centimeters), and upload progress indicator 210, which may show the percentage or fraction of the corresponding 3D model file that is uploaded and/or rendered by the platform. In FIG. 2A, upload progress indicator 210 shows that a first 3D model file with file name M_valve_cap.sti is partially uploaded/rendered. Selecting next step control 212 may cause the developer-user to be presented with the next stage in the process for receiving a quote (e.g., to request a pricing user interface).

FIG. 2B shows another view of exemplary upload user interface 200 in which the developer-user is using cursor 204 to select model upload control 206 in order to upload a second 3D model file.

FIG. 2C shows an exemplary file browser user interface 213 alongside a view of exemplary upload user interface 200 in which upload progress indicator 210 now indicates that the first 3D model file is completely uploaded. File browser user interface 213 may be used to select a 3D model file to upload via upload user interface 200.

FIG. 2D shows a developer-user using cursor 204 to navigate into a folder in file browser user interface 213 in order to select a 3D model file contained within the folder.

FIG. 2E shows that a second 3D model file (named “Car_thingi_whole.stl”) has been selected for upload to the platform, and upload is in progress as indicated via upload progress indicator 210b, while upload progress indicator 210a shows that the first 3D model file has been loaded (e.g., completely uploaded and/or rendered) by the platform.

FIG. 2F shows a view of exemplary upload user interface 200 in which upload progress indicators 210a and 210b show that both the first and second 3D model files have been loaded, and the developer-user uses cursor 204 to select next step control 212 to proceed to the next stage of the quote process.

FIG. 2G shows exemplary pricing user interface 214 for configuring certain parameters on which the price quote may be based. As shown in FIG. 2G, navigation indicator 202 now indicates that the current stage of the quote process is “price.” Exemplary pricing user interface 214 may include a file information selector 216 for choosing information to display about a particular one of the loaded 3D model files; as shown, the first 3D model file is selected and its corresponding information is shown in user interface 214. Pricing user interface 214 may include a model render panel 218 for presenting a visualization of the selected 3D model file. The visualization may be a two-dimensional projection of the 3D model file. A pricing parameter panel 220 is used to present parameters concerning the selected 3D model file on which the price may be based. For example, such parameters may include the maximum dimensions for the 3D model file, the volume of the 3D model file, a selected technology (e.g., a selected 3D printing technique), print options such as the print material, layer thickness, type of filling, desired production priority (e.g., time to job completion or job initiation), and the desired quantity of the prints of the selected 3D model file.

FIG. 2H shows another view of exemplary pricing user interface 214, showing technology selector 222 for choosing a value for the selected technology parameter (e.g., FDM, SLA, or SLM); the selected technology will affect the quote for printing the selected 3D model file. FIG. 2H shows additional information that may be presented in pricing parameter panel 220, namely the incremental costs for: printing each item, post production costs, the selected production priority, the startup cost (e.g., to account for new tooling or a base price for commencing the order); and a subtotal, tax, and overall total for printing the 3D model based on the currently selected parameters. Add-to-cart control 224 may be used to accept the selected parameters for the selected 3D model file and proceed to the next stage of the quote process (e.g., by configuring the parameters for another 3D model file or by proceeding to accept the order).

FIG. 2I shows another view of exemplary pricing user interface 214, in which the developer-user uses cursor 204 to select the second 3D model file in file information selector 216, which will cause the corresponding information to be displayed in model render panel 218 and pricing parameter panel 220.

FIG. 2J and FIG. 2K show additional views of exemplary pricing user interface 214 in which the second 3D model file is selected via file information selector 216, and the corresponding information is displayed in model render panel 218 and pricing parameter panel 220.

FIG. 2L and FIG. 2M show additional views of exemplary pricing user interface 214 in which alternative technologies (SLA and SLM, respectively) are selected for the second model file via technology selector 222, and the corresponding information including the resulting quoted item printing price is displayed in pricing parameter panel 220. FIG. 2N shows another view of exemplary pricing user interface 214 in which the “FDM” technology was re-selected for the second 3D model file.

FIG. 2O shows another view of exemplary pricing user interface 214, showing print options control 226 (e.g., for setting the material, layer thickness, and filling type based on a selected printer) and production priority control 228. In certain embodiments, the print options control and production priority control will be pre-populated with the expected unit price and incremental cost for each available selection, as shown in FIG. 2O. Exemplary pricing user interface 214 may additionally include an order total price panel 230 including a price that accounts for the currently selected parameters for printing all of the loaded 3D model files. Exemplary pricing user interface 214 may additionally include a next-model-options-selector 231 for navigating to the print options control 226 for another loaded 3D model file.

FIG. 2P shows exemplary cart user interface 232 for summarizing item pricing (e.g., print costs for each 3D model file) prior to the developer-user accepting an order. Cart user interface 332 may include item order information 234a and 234b corresponding to the print options and pricing for each 3D model file, and order notes field 236 for providing specific comments to the manufacturer about the order.

FIG. 2Q and FIG. 2R show views of exemplary delivery information user interface 238 for receiving contact information from the developer-user and a delivery address for the order. The delivery address may be used to compute an additional cost for delivery of the order that is added to the order total price.

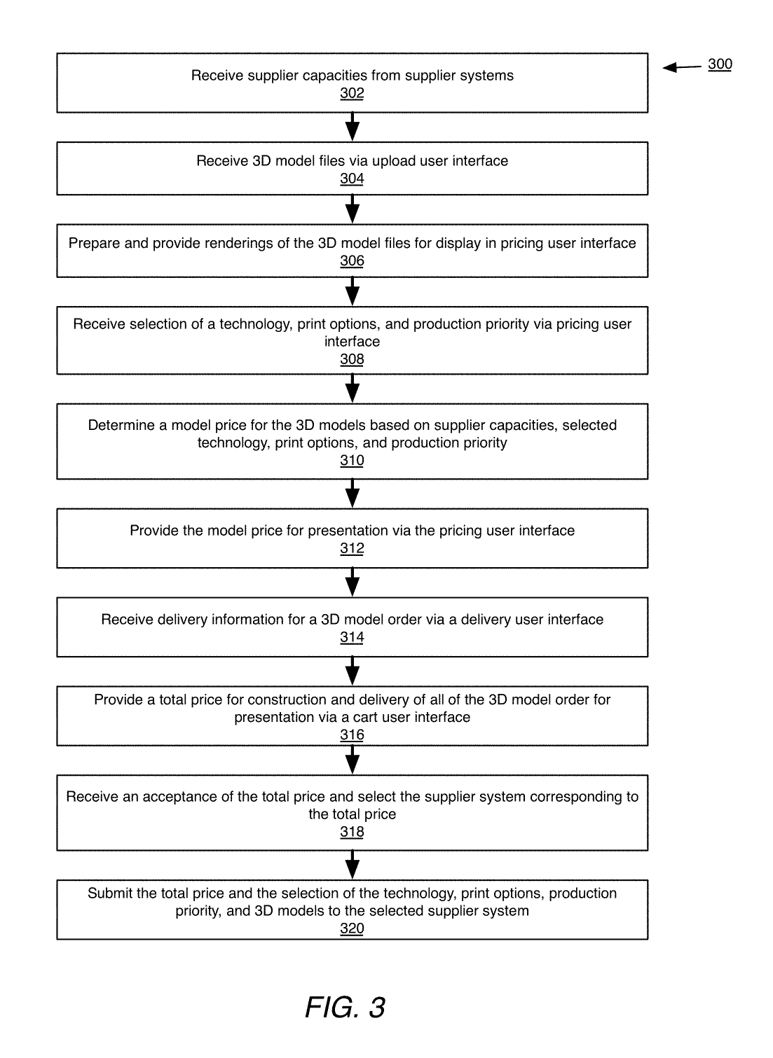

FIG. 3 shows a flow chart depicting an exemplary process 300 for providing services concerning creating order specifications and coordinating orders for manufacturing and distribution of three-dimensional items. A platform server, such as server 150, may receive supplier capacities from supplier systems 160 (302) and store the capacity information in, e.g. database 142. A developer-user, e.g., at client device 110 may later initiate an order for manufacturing a design described in one or more 3D model files, and the 3D model files may be received by the platform server from the developer-user via an upload user interface such as user interface 200 (304). The platform server may prepare and provide renderings of the received 3D model files for display in a pricing user interface at client device 110 such as user interface 214 in model render panel 218 (306). The platform server may receive a selection of a technology, print options, and production priority via the pricing user interface (308). The platform server may determine a model price or item price for one or more of the 3D models based on supplier capacities as received from the supplier systems, the selected technology, print options, and production priority (310). The platform server may provide the determined model price/item price for presentation via the pricing user interface (312). The platform server may receive delivery information for the 3D model order via a delivery information user interface such as user interface 238 (214). The platform server may compute and provide a total price for construction and delivery of each item of the 3D model order for presentation via a cart user interface such as user interface 232 (316). The platform server may receive an acceptance of the total price and select the supplier corresponding to the total price (318). The platform server may submit the total price and the selection of the technology, print options, production priority, and 3D model files to the selected supplier system (320).

While the preferred embodiments have been shown and described, it will be understood that there is no intent to limit the invention by such disclosure, but rather, is intended to cover all modifications and alternate constructions falling within the spirit and scope of the invention.

What is claimed is:

1. A method for facilitating execution of orders for printed 3D models implemented by a processor at a server, comprising:
receiving, by the processor, supplier capacities from one or more supplier systems;
receiving, by the processor, one or more 3D models via an upload user interface by selecting files individually or dragging and dropping;
providing, by the processor, a rendering of the one or more 3D models for display via a pricing user interface;
receiving, by the processor, a selection of a technology, print options, and production priority via the pricing user interface;
determining, by the processor, a model price for a respective one of the one or more 3D models based on the supplier capacities, the technology, print options, and production priority;
providing, by the processor, the model price for presentation via the pricing user interface;
receiving, by the processor, delivery information for the order of one or more 3D models via a delivery user interface;
providing, by the processor, a total price for construction and delivery of all of the one or more 3D models for presentation via a cart user interface;
receiving, by the processor, an acceptance of the total price and selecting the supplier system corresponding to the total price; and
submitting, by the processor, the total price and the selection of the technology, print options, production priority, and the one or more 3D models to the selected supplier system.

2. The method of claim 1, wherein the capacities concern one or more of injection molding equipment, 3D printing equipment, toolings, raw materials, and geographic access.

3. The method of claim 1, wherein the upload user interface indicates the upload and rendering progress of each 3D model file.

4. The method of claim 1, wherein the upload user interface requests model units in millimeters, inches, or centimeters.

5. The method of claim 1, wherein the pricing user interface provides a control for presenting a view of any one of the one or more 3D models.

6. The method of claim 1, wherein the pricing user interface provides a control for receiving a quantity of prints for each 3D model of the one of the one or more 3D models.

7. The method of claim 1, wherein the processor determines a lightweighted model version of each of the one or more 3D models, and the model price is based on the lightweighted model version.

8. The method of claim 1, wherein the total price incorporates a cost for a user-selected distribution solution.

9. The method of claim 1, wherein the total price is provided as one quote in an auction comprising a plurality of supplier quotes.
